(19) United States
(12) Patent Application Publication
(10) Pub. No.: US 2002/0055037 A1
(43) Pub. Date: May 9, 2002

(54) BIPOLAR CATALYTIC CELLS

(76) Inventor: KENNETH DALE RHOTEN, STOY, IL (US)

Correspondence Address: KENNETH D RHOTEN, 9981 FIREBAUGH BOX 225, STOY, IL, 62464

(21) Appl. No.: 09/301,227

(22) Filed: Apr. 29, 1999

(51) Int. Cl. H01M 2/18; H01M 4/70; H01M 4/58

(52) U.S. Cl. 429/136; 429/138; 429/139; 429/239; 429/240; 429/221

(57) ABSTRACT

An environmentally responsible and non-toxic alkaline cell, both catalytically and electrically rechargable, consisting of one or more iron anodes, as well as a zinc cathode, all immersed in an aquaous solution of potassium hydroxide in a plastic container. The cathodic material is cast zinc and is preferably wrapped in a special sheet of studded rubber provided with either a semi-perforated edge or a specially serrated edge on both sides to permit ionic communication between anodes and cathode. This rubber sheet should also be equipped with diagonal grooves on at least one side of the material. The anodes consist of thin, mild steel stampings, made to a special pattern, and are preferably blued to resist rust. The tips of these anodes are then coated with a paste prepared from one part 100 mesh iron powder to one part 100 mesh activated carbon powder. To form the paste, the powders are first thoroughly mixed dry and then properly wetted with distilled water. After both sides of the anode tips have been properly coated with the paste, they are then covered with tightly woven nylon sacks which are made to snugly fit over the tips. These anodes, being perforated, are then folded and tightly closed, thus forming dual anodic configurations which can be, by varying the length of the connective strip between them, readily doubled, tripled or even quadrupled. They are mounted in saddlebag fashion around the zinc cathode. The plate separator consists of a hard rubber ring with a flat bottom, supplied with one or more vertical notches, corresponding to the one or more anodes designed to rest in them. When the cell is fully assembled with a hard rubber cover,properly sealed and provided with a vent, filler opening and plug, the electrolyte is then added and is topped off with a special oil mixture. The cell thus made, having been thoroughly activated by electrical charging, will tend to resist most of the chemical reactions of discharge by catalysis until saturation and its resultant crystaline product must be reversed by electrical charging.

### BACKGROUND OF THE INVENTION

The invention relates closely to that class of batteries which are commonly referred to as secondary cells. These are distinguished from primary cells in that they are devices which store chemical energy. Almost always a chemical change is brought about in such cells by the application of an electrical charging current. That change in chemical composition is only semi-permanent as it is immediately reversed by discharging the cell. The fact that such cells can be repeatedly charged and discharged in nitrous cycles has made such batteries a practical necessity in modern life. The original secondary cell, and the one that is still in most common use throughout the world, is the so-called lead-acid cell. This was the invention of Gaston Plante, who constructed the first lead cell in 1859. Despite its undisputed success, the lead storage cell has always been plagued with troublesome flaws and inherent defects. First and foremost, lead is extremely poisonous. Therefore, manufacturing lead batteries is made hazardous by the element so fundamental involved in the cello's chemistry. Then the recycling of discarded cells makes for another hazardous industry, complicated further by the corrosive action of the sulfuric acid electrolyte. Therefore, the toxic nature of the element itself heads a list of problems involved with the lead cell that over a century of dedicated development and manufacture cannot fully overcome to the satisfaction of all concerned.

Despite the fact that lead cells are quite powerful and compact, owing to the inherently high-energy oxygen bond, the discharge chemistry of the cell represents another fundamental flaw in the lead-acid scheme. The discharge products include water, which is immediately subject to freezing. Lead sulfate, another discharge product, is almost completely insoluble in water. In addition to this, anode disintegration frequently occurs in cells left discharged for a long period of time and they became permanently damaged. In other words, though seldom encountered in most applications of the lead cell, lead batteries tend to freeze in the fully discharged state. Not only this, but yet another calamity besets the lead cell. Due to the insoluble lead sulfate which accumulates internally anodes and cathodes become completely covered with the substance and this constitutes a nuisance which is often irreversible. In terms of performance, the cells show only a limited capacity for recovery after heavy discharge. This is due to a small amount of lead peroxide which still remains at the anode, soon to be depleted entirely. All too frequently lead cells go dead at places where recharging is impossible, thus disabling whatever equipment is to be powered by them.

Despite the relatively high voltage of the lead cell, one immediately notices the extremely heavy weight of the batteries in actual practice. The corrosive action of dilute sulfuric acid upon steel equipment, the battery terminals and whatever else it comes into contact with is just another quirk of the lead cell frequently encountered. In other words, the factual history of the lead cell in everyday use is so full of trouble that its continued use is due only to its relatively law cost, the high energy level of the battery, and the lack of any suitable replacement chemistry.

The first successful effort to develop a suitable replacement for the lead-acid cell which actually led to he introduction of a commercial product was conducted by Thomas Alva Edison at his laboratory in Menlo Park. This cell was based on the two metals, nickel and iron. While the lead call, more appropriately termed the lead-hydrogen cell, relies upon the very slight difference in oxidation potential for lead and hydrogen in dilute sulfuric acid as its basic operating principle, the Nickel-Eron Cell developed by Edison was much different. Contrary to much erroneous information published about the battery and its chemistry, this cell was based on the rare property of a compound, nickelous hydroxide. This compound, Ni(OH)₂ normally contains only two hydroxyl ions. But upon electrically charging this cell, with this substance at the anode, yet another ion is absorbed to form the compound Ni(OH)₃, or hickelic hydroxide. The electrolyte in these cells is a 20% solution of potassium hydroxide to which has been added approximately 1% lithium hydroxide. Both anodes and cathodes are steel containment apparatus which have been plated with nickel. While nickelous hydroxide is employed at the anode, extremely fine powdered iron is used at the cathode. These are the correct chemical components of the Edison Cell and were determined by actual laboratory test as well as through available public information. Upon electrical charge, the nickelous hydroxide is transformed into Ni(OH)₃. By discharging the cell, the nickelic hydroxide oxidizes the iron at the anode to form insoluble Fe (OH)₂, or ferrous hydroxide. This compound is stable only when immersed in aquaous alkaline solutions. By charging the cell again, the ferrous hydroxide is reduced to metallic iron. Contrary to popular belief and proven in the laboratory, the true oxides of iron and nickel cannot be employed in such cells. The hydroxyl ion, weakened somewhat by the hydrogen bond, permits temporary bonds that can be made and broken at will. The oxygen bond alone is simply too strong to break, in most two-metal cell schemes, as actual tests prove out with such metal oxides as ferrous oxide and nickel oxide. Indeed much erroneous information in print on the Edison Cell chemistry can be very easily traced to Edison, s efforts at preventing competitors from copying his cells.

The advantages of the Edison Cell over the lead-acid cell, however, proved numerous. They were lighter than lead cells, even though they tended to require larger banks of more individual cells to produce the same voltage and ampere-hour capacity. The specific gravity of the cells remained relatively constant, regardless of whether the cells were charged or discharged. The voltage of the fully charged cell was 1.25 volts. Even though this was substantially lower than the voltage of the lead cell, it was still high enough to permit practical applications of the battery. The cells were also mechanically strong and proved to be very long lived in actual service. In all, the Edison Cell had decided superiority over the lead-acid cell in all but two respects. Nickel, the element upon which the battery was heavily dependent, is not a common element and the majority of the world's commercial supply is mined from deposits located in the Sudbury district of Ontario. Therefore, though not truly rare, nickel is in fairly limited supply which restricts its use in batteries on the same commercial scale as lead. other principal difficulty with the Edison Cell was that the overall cost was higher than comparable lead cells, even though mach of this cost was due to the ruggedness in design and materials that Edison insisted upon. The nickel-iron cell was also dependent upon a source of electrical current to maintain its charge. Once deplete d of its charge, the cell had little capacity for recovery. Later it would also be discovered that nickel is carcinogenic, while the industrial hazard is chiefly the metal dust and those of its compounds, such as nickel hydroxide.

The search for yet another secondary cell system leads one into a number of exotic chemistries, none of which offer a higher energy-to-weight ratio than the silver-zinc cell. Two limiting factors immediately restrict its utility. The high cost of silver is obviously the primary disadvantage of the cell. One little known problem also restricts silver-zinc cells to specialty applications. Since the electrolyte is almost always alkaline, the slight solubility of silver oxide in potassium hydroxide solutions causes the electrolyte to turn dark over time. This permits the silver ion to migrate to the cathode and foul the zinc. Therefore, the silver-zinc cell is only practical when constructed as a dry battery.

Of course there are literally hundreds of various cell designs that are capable of being recharged, but for reasons unique to each concept, none have offered much hope in the replacement of the lead-acid cell. Copper oxide and zinc cells, based on the original Leland cell, tend to have metal migration problems much like silver cells. The copper ion, despite the best efforts to contain it, is very slightly soluble in alkali and therefore eventually fouls the zinc. For example, a promising cell constructed during the course of this research consisted of the basic sulfate of copper in a stainless steel anode, coupled with a zinc cathode in a weak alkaline electrolyte. This cell too suffers from metal migration as copper inevitably finds its way to the zinc cathode and fouls it.

The seemingly limitless numbers of potential combinations of metal pas, chemistries and configurations possible in the alkaline chemistry certainly point to the reason why Edison focused on the hydroxyl ion in his research. One need only research the acid chemistry to plainly see that what is possible is far less desirable. One simple reason is that most metal salts tend to be soluble in their respective acid counterparts. To the contrary, most metal hydroxides are insoluble in alkaline solutions. This is another factor which has led so many chemists to the alkaline electrolyte, as an insoluble oxidant must be physically retained at the anode before a successful system can be constructed.

The systems made possible by the original research were therefore quite numerous. The nickel-cadmium cell was one such development in which cadmium was substituted for the iron cathode in the original Edison Cell. Another interesting cell is the nickel-zinc cell, also based on the Menlo Park research. While zinc is relatively harmless, the substitution of cadmium for iron has led to difficulty owing to the inherent toxicity of the element. Considering such cells are typically dry, disposal and recycling problems have arisen from their use.

Other lesser known and more exotic batteries some incorporating lithium or magnesium for example, have been devised and some exhibit rather extraordinary characteristics. Yet all hinge upon some technological feat of magic or rare substance for their manufacture, often at costs which prohibit their mass production and introduction to the public on a large commercial scale. Therefore, for these and a long list of other reasons too complex to enumerate, the lead-acid cell still predominates in heavy work for both home duty and industrial applications. The background of the present invention is set in this foregoing context, mentioned as a necessary introduction to the complex predicament encountered in the development of a new, commercially viable and environmentally responsible substitute for the lead-acid cell.

An exhaustive study and a lengthy series of actual laboratory tests of metal pairs, possible configurations and chemical elements, revealed relatively few practical systems that show any hope at all in providing a new alternative to the lead cell as it is currently used. Eventually, through extensive study of the physical constants of the elements and their compounds, as well as well as literally hundreds of experiments, the field of work narrowed to two fundamental elements that the new cell chemistry must be based on: iron and zinc.

The abundance of non-toxic iron and its unique reactions in alkaline electrolytes are among several reasons why iron is so important to developing a new standard in secondary cells. The insolubility and stability of ferrous hydroxide in alkali are also fundamental characteristics which are very important. Therefore, under very specific and controlled conditions, iron becomes the ideal anodic substance for use in secondary cells.

The relatively low cost and availability of zinc are some of the initial characteristics which make the element an ideal choice for cathodic material. Not to mention the long, successful history as a battery metal, its low toxicity to animal life makes it environmentally desirable. Its relative position on the activity scale in relation to iron is perfect for the construction of practical cells. Lastly, two important properties proved crucial to the development. The metal tends to readily electrodeposit, differing from aluminum, for example. Another physical constant of zinc is that its hydroxide is soluble in alkaline solutions.

As early iron-zinc cells constructed during this development process showed low energy levels and little commercial potential, the development of a successful cell hinged first and foremost on a successful and rugged anode. In fact, one will note that the lack of such a suitable anode has impeded the development of zinc cells to the acme that should have long been standard. With regard to the present invention, the balance of the development followed the development of the anode. The basic steel shell and fabric liners containing insoluble compounds ironically had been developed by the inventor for an earlier cell of a different chemistry. Yet the fundamental concept was quickly adapted to the iron cell. One truly accidental discovery during the anode development which was literally the most important of all in the various experiments was the mixture of activated charcoal or commercially prepared activated carbon powder with extremely fine iron powder. The powders were thoroughly mixed dry and wetted with a small amount of distilled water or other suitable solvent. The resultant paste was then applied to the anode tips and covered with a snugly fitting nylon sack. When encased in an outer steel shell, it was found that the resultant anode, when charged or activated, exhibited remarkable recovery characteristics hitherto unknown in any other cell. To be perfectly honest, after being discharged and put aside for a number of hours, the cells appeared to literally charge themselves. After another series of tests verified the automatic formation of ferrous hydroxide within the anode, it was reasoned that minute “cells” were actually created by this admixture. The carbon particles tended to act as anodes and the iron particles as cathodes. Immersed in an alkaline electrolyte, this mixture logically and automatically leads to the formation of ferrous hydroxide, with or without the application of charging current. In other words, the cells were undeniably self-energizing. Numerous “cycles” were now possible in the operation of the cell without the frequent application of electrical current, virtually unknown in human experience with secondary cells of the past.

These characteristics are made possible by the automatic formation of the ferrous hydroxide at the anode which represents an, insoluble oxidant, and a ready supply of zinc reductant at the cathode which slowly dissolves in the electrolyte until the solution becomes saturated. These principles determined the nature and substance of the cells that would follow. The unique process by which the cell operates was termed “bipolar catalysis”. The cells show almost complete recovery for quite a large number of cycles before electrical charging is necessary, and this is done chiefly to redeposit zinc onto the cathode and restore the electrolyte to its normal composition. The flexible steel anodes are not affected by the alkaline electrolyte and offer both low cost and practical manufacturing advantage over expensive pure carbon anodes, thereby being perfectly suited for larger) multi-plate batteries for heavy duty applications.

While these aspects of the invention were important in overcoming the historic obstacles in the development of a new standard for secondary cells, yet other features had to be developed in order to solve problems unique to this cell's chemical reactions. For one thing, zinc deposited on the cathode during charging tends to be spongy at best, or even mossy in character at higher voltages. The adhesion is usually fair during electrical charging, but the self-energizing cycle tends to leave deposits which adhere so poorly that particles of zinc fall from the surface of the cathode to bottom of the cell. Mossy deposits also can be inadvertently loosened by mechanical movement, which is even predictable in mobile equipment in which such cells have been installed. Therefore, some means had to be provided by which the tenacious deposits could be more easily managed, contained and prevented from shorting against the anodes. What was developed over time was simply a sheet of flexible rubber, provided with short, uniformly spaced studs on one side which contact the zinc cathode and therefore create a space in between the zinc and the rubber sheet where the tenacious deposits may safely form and be stored. It was found that over ninety percent of the surface area existing between cathode and anode may be covered with insulting material and yet not affect the efficiency of small cells. The rubber sheet may have serrated edges to aid in ionic communication. The cathode is then wrapped in the material. A terminal stud is provided in the cathode by drilling and tapping at the appropriate location. The tapped hole is then cleaned with solvent. Employing a stainless steel stud, a silicone sealer is applied to both of the mating parts and then the stud is screwed into the cathode, tightened and wiped clean. The sealer, when properly applied, prevents alkaline attack of the electrical junction. Upon final assembly of the cell, more sealer can be applied to the stud prior to insertion into the cell top. This prevents a local bi-metal effect at the junction and leakage at the cell top.

In addition to the rubber sheet previously described, a secondary plate separator had to be developed which permitted ease of assembly, separation of cathode and anodes as well as mere anodic separation. Since it was found that a significant energy boost could be obtained by employing four anodes to one zinc cathode, the secondary plate separator could simply be a rubber oval-shaped ring, fitted around the cathode and rubber sheet. Obviously, one difficulty with this design was that no means existed by which the anodes could be held in fixed position. Early separators employed in test cells often were slotted hard rubber devices which were fitted in between the plates prior to battery assembly. The difficulty with this design is in its application to zinc cells and the mossy zinc nuisance which plagues them. These deposits can extend as far as a quarter inch from the solid cathode upon formation. Another difficulty with slotted separators is that they tend to make assembly difficult, as anodes and cathodes must be pushed into the slots at opposite ends. Also a problem is the fact that slotted separators rely upon friction to retain position in the cells. Batteries in service under adverse conditions may show slippage of such separators for this reason.

All these considerations led to the development of a highly specialized plate separation system, simplified into two simple low-cost components. Since electrical insulation was the only necessary protection between cathode and anodes, a simple ring was found to be the minimum protection required. Even better was a configuration with a flat base molded as a part of the ring, as well as four flexible members intended to serve as separators between anodes. This permits greater chemical activity, particularly the anodes become encrusted with zinc hydroxide and would otherwise fail to permit electrolyte contact on all plate surfaces. Therefore, even the development of the plate separator, smartly molded as one simple component, was the subject of intense investigation into the unique requirements of this cell's action. Since zinc is far more active than iron, the single, but rather thick zinc cathode is deliberately designed to reduce the surface area of the zinc. The four anodes, consisting of two or more saddle-bag pairs, are also intentionally conceived to increase the activity of the iron. While the efficiency of the anodes is reduced somewhat by such an arrangement, the overall energy level of the cell is improved considerably over the use of merely one pair of anodes. The flat anode shape is considered now to be standard as anode efficiency is best when the active chemical insolubles are in close proximity to the current conducting surface. The “fingers” of the anode separator are simply manipulated by hand during assembly between the respective anodes, and the whole assembly is then inserted into the case. In large cells of substantial plate width, two or three such separators can be employed, made of a suitable insulating material.

Relatively little new development was required for battery case design including cell tops. All of the standard concepts and materials proved readily adaptable to this cell, so long as the materials were not adversely affected by alkali. The cases were best made of polystyrene or polypropylene, with conventional compartments for multi-cell batteries. The covers, particularly for simple cells, are best made of hard rubber, or of suitable plastic. Glass is to be avoided except in prototype work, as the glass itself comes under slow attack by the alkaline electrolyte. In large multi-cell batteries of any appreciable voltage, the terminal studs are avoided at the series-connected cells themselves and are provided only at the respective poles of the series bank. In multi-cell batteries, zinc coated steel strips copper-plated at the opposite end, may be inserted into the molten zinc in specially adapted molds to provide flexible electrical connectors. The connecting strip at the anode tops may be copper-plated as well to make for soldered connections at time of assembly. The battery tops in these cases may be equipped with a wall of up to a half inch around the edges within which may be poured a suitable sealer. This arrangement, on the order of the “pitch” sealer once used in lead cells of early manufacture, protects the soldered electrical connections from the elements as well as electrolyte attack. So many pourable sealants now exist that a suggestion is only made that a product suitable and compatible with the battery materials which is also alkaline resistant should be employed.

The development of these cells led to a number of curious improvements. It was observed that during electrical charging, alkaline cells often evolve a caustic alkaline mist due to the gases given off by electrolysis. For this reason, a layer of light oil was added to the electrolyte fluid which considerably reduced this spray. A mixture of three parts mineral oil to one part lamp oil was found to be the best for this purpose. Over time, however, it was found that the oil layer did far more than reduce alkaline mists during electrical charging. It also reduced the rate of evaporation of the water present in the electrolyte. The oil coated, upon the slightest agitation of the cell, the exposed metal cathode and anodes, thereby reducing the risk of their oxidation by exposure to air. The oil layer also reduced the solubility of atmospheric carbon dioxide in the electrolyte by providing a barrier to the electrolyte surface. Carbonate formations in the electrolyte are thereby reduced. Also, by reducing alkaline spray, alkaline deposits are reduced near the cell top. Generally speaking, the oil layer helped preserve the alkaline electrolyte and its associated products in the cell and thereby permitted the cell to continuously function as it was designed. Indeed, the pennies involved in the use of this inert additive are repaid many times by the considerably extended life of the batteries in actual field service. Therefore the oil layer, of the composition stated previously, has become a standard feature of these cells.

Now summarizing the background of this invention, the historical necessity of an improved secondary cell is evident. Yet since the development of electrochemical cells is among the most difficult challenges in both the art of manufacturing and to science as well, to set a new standard required a far more pragmatic view of the problem than ever before. Therefore, this historical background of the invention shows how, by competent research and development, augmented by experience in cost-conscious manufacturing on a large modern scale, a sophisticated new and novel cell has been devised which exhibits all of the earmarks of a basic invention, and a fundamental departure from systems of the past. Not only this, but as well, many features described herein are applicable as improvements to known, existing cells, thus making this work an important contribution to the art of making secondary cells.

### BRIEF SUMMARY OF THE INVENTION

The primary object of this invention was to develop a new standard for wet secondary cells, superior to known cells in a great many respects. This goal was achieved by a number of separate, novel features, each painstakingly devised to serve an important, integrated purpose. The harmonious function of these various features, such as the chemistry, the elements, the materials, as well as the various components involved, together represent the essence of the invention. Also, the ramifications of the teachings of the invention cannot be limited merely to the characteristics of the cell, but are instead appreciated in numerous practical applications in which those characteristics make real world sense. These various applications may have been served formerly by some other cell, but are now served best by this cell. In no way can one begin to list the improvements of this cell over the prior art without first pointing out its most important advantage; its self-energizing capability. Other cells show a capacity for recovery and in some cases a good reserve. But this cell exhibits the proven and tested ability to catalytically reverse the effects of discharge, thereby permitting a very large number of discharges without any immediate need for electrical charging. This novel characteristic alone makes for limitless possibilities in the field. In automotive applications, these cells make emergency starting of engines possible in situations and circumstances that would be impossible with ordinary lead cells. Even though equivalent ampere hour capacity requires larger batteries, because lead is so inherently heavy, the iron-zinc cells are lighter. The space requirements to accomodate iron-zinc cells over lead-acid are not unreasonable, nor unrealistic. In aircraft applications, these cells could provide radio communication long after generators have failed, even many weeks after emergency landings in remote locations. Wind and solar electricity may be readily converted into chemical energy and efficiently stored at a somewhat higher energy level in these cells than the catalytically energized voltage. Wind and solar technologies have been severely hampered by lead cells which are inefficient, troublesome and short-lived. The iron-zinc cell promises an economical alternative to known storage cells in these applications owing to the unique system requirements of wind-generated electricity and solar electric panels. In fact, these energy alternatives make even more sense now that a battery has been developed that is not prone to freezing during the winter months. Bitter experience with the lead-acid cell includes instances of frozen cells during the coldest winter weather resulting in irrepairable damage. This often includes rupture of the cell case. A typical cause was commonly corrosion at the terminals often in those cells which were hidden from view in large battery banks where ready access to all cells was difficult or impossible. Due to uneven charging of the cells, they tended to discharge to the extent that the electrolyte composition was largely water, immediately subject to freezing during typical arctic air mass conditions suffered so commonly during the winter by much of the nation. The repairs to these banks were also hampered by the temperatures which caused the damage and made the poor connections evident. Emergency decisionmaking under severe weather conditions often results in quick-fix remedies. Repairs made during sub-zero temperatures are hard on the workmen and may even leave the bank more Operable than before the repair was attempted. Therefore, a large bank of iron-zinc cells makes much more practical sense for use in alternative energy systems than known cells.

Since a new standard for secondary cells must meet a wide variety of requirements and serve a great many purposes, numerous other objects of the invention are set forth herein for the purpose of outlining the great versatility and general utility of these cells.

It is a primary object of the present invention to provide a secondary battery which is reasonably safe and environmentally desirable. The basic elements chosen for this cell are iron and zinc, therefore making the chemistry as low in toxicity as is humanly possible.

Another object of the invention is to provide a secondary battery with unique recovery characteristics. In other words, it is an object of the invention to provide a battery which, given sufficient ti, regenerates a substantial portion of its charge automatically, and does so in numerous cycles until it must finally be electrically charged.

A further object of the invention is to provide a battery which can be cheaply manufactured using high-speed production technology. Equally important are the readily available elements and common materials employed in it manufacture, therefore making possible a commercially viable, cost-effective product.

Still another object of the present invention is to provide a battery which incorporates an alkaline freeze-resistant electrolyte that maintains a relatively constant specific gravity throughout the complete cycle of charge and discharge.

Yet another object of the invention is to provide a simple and effective plate separator system which is easily incorporated into the battery during manufacture.

An additional object of the present invention is to offer a battery with exceptionally long anode life as well as cathodic resistance to premature failure.

Another object of the invention is to provide a means of preventing alkaline mists during charging and reducing carbonate formations in the electrolyte by a unique layer of light oil which floats upon the electrolyte surface.

Having cited various objects of the invention, the means by which they are attained are summarized as follows:

An alkaline cell consisting of an aquaous solution of potassium hydroxide in a plastic or other suitable container in which is immersed a zinc cathode wrapped in a special sheet of studded insulating material with either a serrated or semi-perforated edge on either side to permit the flow of ions. This sheet should be provided with diagonal grooves on at least one side. The preferred embodiment employs anodes made of thin mild steel being commercially prepared as stampings, and are chemically blued according to known processes. A paste is prepared from 100 mesh iron powder and 100 mesh activated carbon powder in equal volume. The dry powders are first thoroughly mixed and wetted with an appropriate solvent such as distilled water. The tips of each anode are then coated with the paste and covered with specially made nylon sacks which are made to fit snugly over the anode ends. These anodes being perforated, are subjected to various bends and are closed securely by special tabs. These form dual anodes which can be doubled if required. They are mounted in saddlebag fashion around the zinc cathode. The plate separator is constructed as a hard rubber ring with a flat bottom which incorporates a series of vertical notches which correspond to the anodes which are to rest within them. The cell is provided with a cover made of hard rubber into which is incorporated a vent, filler opening and plug or closure. After the electrolyte has been added, a special oil is added which floats atop the aquaous alkaline solution. The cell is then activated by electrical charging. The cell will tend to automatically reverse most of the chemical change brought about by discharge until the solution becomes saturated by zinc hydroxide. The crystaline compound can only be dissolved by electrically charging the cell.

### BRIEF DESCRIPTION OF DRAWINGS

FIG. 1 is a front view of the device with sectional detail of the cell case. The cell covers the terminals, and a partial cutaway of the cathode assembly are shown, illustrating the terminal stud as it threads into the cathode. The balance of the components shown are depicted as they would normally appear. The section is taken at 1-1 in FIG. 2.

FIG. 2 is a side view of the device, shown predominately in sectional form, as 2-2 in FIG. 1. The anodes are not illustrated in sectional form, but diagrammatically represented as 3, a typical anode specimen.

FIG. 3 is a diagram which depicts by way of symbols the catalytic process which takes place in the cells.

FIG. 4 is an exemplary illustration of the cell's fundamental operation in its simplist form.

FIG. 5 is a group of equations which represent the reactions th occur in the cell upon discharge.

FIG. 6 illustrates by way of equations the reactions which occur in the cell as it charges, either electrically or catalytically.

FIG. 7 is an illustration of a typical anode blank, presumably as a stamping.

FIG. 8 depicts the assembly of the anode, including internal components.

FIG. 9 depicts the first steps of the process of bending the anode assembly.

FIG. 10 depicts further bending of the anode assembly.

FIG. 11 illustrates the next important bend of the anode assembly.

FIG. 12 shows the anode assembly complete with tabs 32 bent inwardly and tightly impressed upon the assembly.

FIG. 13 illustrates the final bends in the anode assembly.

FIG. 14 illustrates the drilling, tapping and sealing for a terminal stud located at the top of the cathode.

FIG. 15 depicts the primary cathode assembly, showing the terminal stud tightly threaded and sealed into place.

FIG. 16 shows the cathode assembly after having been wrapped in a special sheet of studded insulating material and held together by the plate separator.

FIG. 16a is a detail drawing of the special sheet of studded insulating material, noting groove detail, and either a semi-perforated edge or a serrated edge as shown.

FIG. 17 depicts a zinc cathode in which a strip of steel has been integrally cast into the molten zinc.

FIG. 18 is a top view of the special anode design required for series battery construction.

FIG. 19 is a side view of a special anode design required for series battery construction.

FIG. 20 is a schematic top view of a 12 volt battery constructed from cells such as those described herein, showing the series connections.

FIG. 21 depicts the same multi-cell battery in a front view, showing the cover ready to be sealed in place.

### DETAILED DESCRIPTION OF THE INVENTION

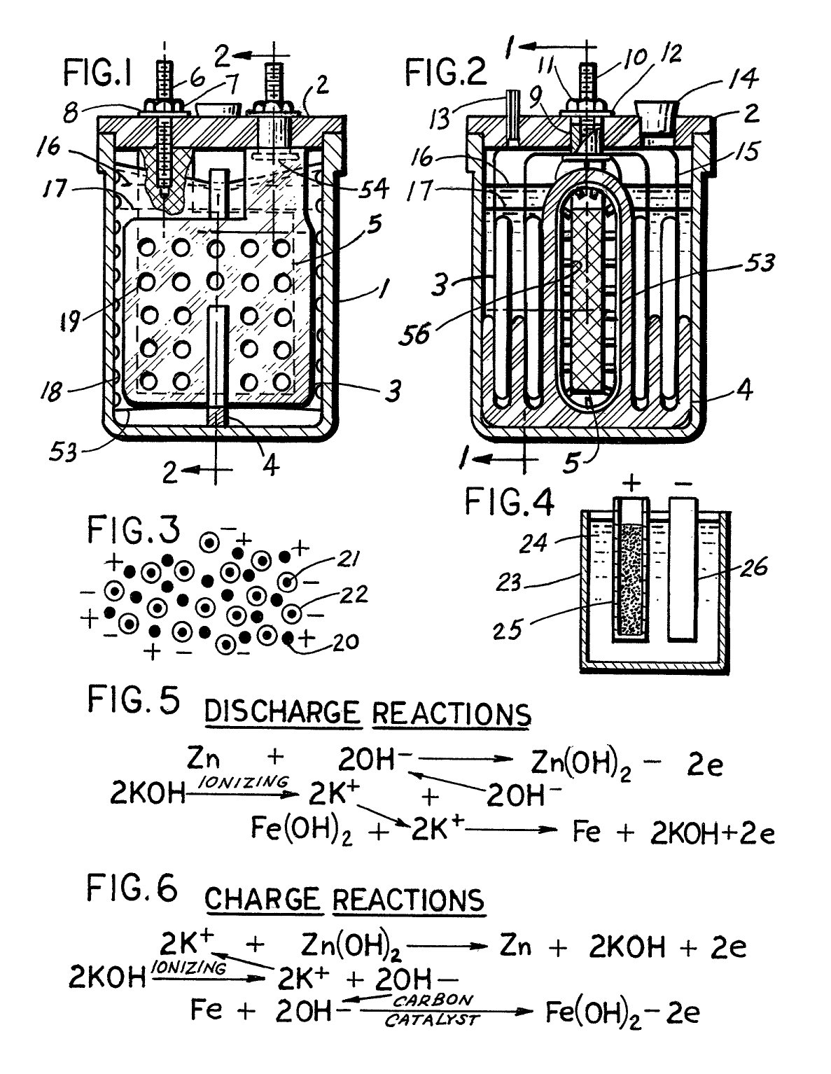

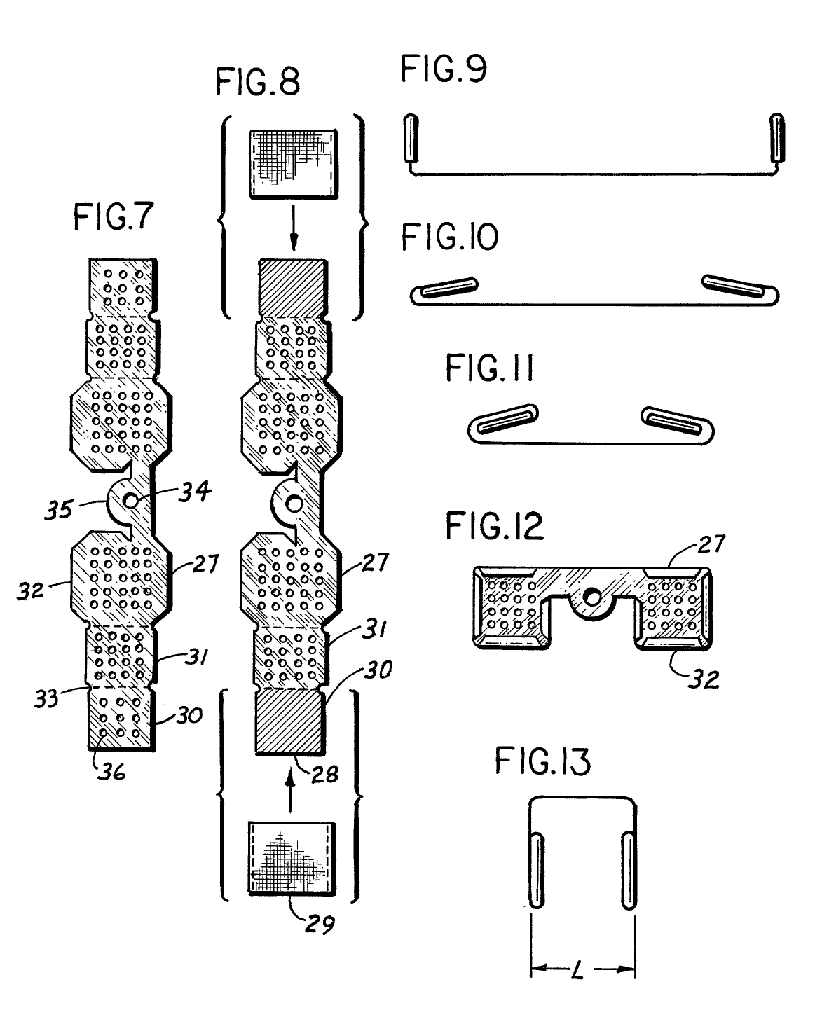

Referring again to the drawings, FIG. 1 shows an electrochemical cell comprising anodes 3 and cathode 5 immersed in an aquaous alkaline electrolyte 17, consisting of one part potassium hydroxide dissolved in four parts water. Container 1 is employed to house the working and inert components of the cell as well as acting as a simple jar containing the active electrolyte. Floating upon the surface of electrolyte 17 is protective oil layer 16, which is depicted more clearly in FIG. 2. Typically, this oil should consist of three parts mineral oil to one part lamp oil. The purposes of this protective oil layer are manifold. At ordinary temperatures, the oil layer will tend to retard evaporation. It will also tend to prevent alkaline mists from spraying upward during electrical charging. Related to this purpose is the additional purpose of preventing dry alkaline deposits from forming in the upper cavity of the cell above the electrolyte which often result from such mists. The oil will also, upon the slightest agitation or movement of the cell, tend to coat the metal components in the upper cavity above the electrolyte and protect them from unwanted corrosion. Yet another purpose served by the oil layer is the prevention of carbonate compounds in the electrolyte due to atmospheric carbon dioxide which would otherwise tend to dissolve therein. The protective oil layer, by preventing carbon dioxide from dissolving, tends to reduce these unwanted reactions and keeps the electrolyte chemistry within the realm of the desired compounds.

The exact construction of anode 3 is given later, but it is first noted that holes 19, which are protected internally from spillage of chemical contents by a nylon liner, permit permeation of the insoluble anodic chemical contents by the electrolyte. Plate separator 4 is shown in FIG. 1 and holds both anodes and cathode in proper place to prevent them from short-circuiting as well as making unwanted mechanical movement of the components within the cell impossible.

The plate separator is best constructed from hard rubber, as is cell cover 2. The material is, on the one hand, rigid enough to provide strength and durability in these applications, as well as being flexible enough to withstand shock. The hard rubber is also inert with regard to alkali and is relatively cheap. Plastic, such as polypropylene, is an acceptable substitute. Cell cover 2 is provided with four holes. Two of the holes are provided for electrical terminals, such as terminal 6. Of the two remaining holes, one hole is provided for a vent, shown in FIG. 2, into which is inserted vent tube 13. This tube may be long enough to allow for the fitting of a ventilation hose, particularly in large, multi-cell banks. The remaining hole is providing for filling and cleaning, normally closed by fill plug 14.

FIG. 2 shows a cross-section of the cell and reveals more detail of cell components. For reasons of clarity, the anodes, as exemplified by anode 3, are not shown cut away for purposes of simplification. Therefore, superimposed over the section are important anode terminal details which are shown in order to clarify materials and terminal construction. With an all-important knowledge of the principles of bi-metal corrosion in mind, it is evident to most skilled persons that if two unlike metals are exposed to an electrolyte, particularly when of the same assembly, corrosion will often result upon the surface of the most active metal. Since it is best to employ stainless steel for cell terminals in these batteries, one must design in such a way as to avoid exposing both the stainless steel and the ordinary mild steel (such as SAE 1006 through 1015) which is employed in the anode construction. One way to achieve this effect, depicted later on in the drawings, is to spot-weld a stainless stud to the center of the anodic connective strip, while at the same time protecting the anodes from heat and splatter. Another method involves the employment of a special nut. This device is depicted clearly in FIG. 1 as special nut 54. FIG. 2 shows a small cutaway section of the nut, which is course to be of the sane or similiar alloy as the anode stamping material, and then blued in the same manner as the anode itself. Threaded stainless steel stud 10 is first coated with a suitable silicone sealer and is then tightly threaded into special nut 54. The sealer is employed again, this time around the holes provided in the anodic connective strips as well as the tubular portion 9 of special nut 54. Now, with the terminal stud tightly sealed and threaded into special nut 54, the terminal assembly is inserted through the holes in the anodic connective strips, shown in the drawing as 1 in FIG. 2. Finally the whole assembly (in actual practice this includes the cathode assembly described later) is inserted through the appropriate terminal hole provided in cell cover 2. Assuming of course that the balance of the cell assembly is done in proper sequence, washer 12 and nut 11 may be placed over stud 10, and then tightened appropriately. Sealer should be applied to this assembly in any way found to be advantageous, as the substance protects terminal connections without sacrificing conductivity.

Referring again to FIG. 1, terminal 6, also constructed of stainless steel, is similarly coated with a suitable sealer and is threaded into a previously tapped hole provided in the zinc cathode. The cathode itself is to be cast from the purest special high-grade zinc and is shown more clearly in sectional form in FIG. 2 as cathode 5. A partial cutaway view of the cathode is also depicted in FIG. 1. The remainder of cathode detail is shown in phantom outline as cathode 5. Washer 8 and nut 7 are added during assembly.

While vent tube 13 and rubber plug 14 are enumerated in FIG. 2, these features require some explanation to appreciate their importance in the device. Departing from sophisticated features employed in the past for fill and vent provisions, generally incorporated into one device, simplicity is reverted to in this design with superior reasoning. A rubber plug 14 is provided for easy removal, and also functions as a safety device which may pop out under internal cell pressure. A typical threaded cap cannot do so. Also, due to the possibility of alkaline deposits which may on occasion plug the vent or coat the underside of the rubber plug, gas pressure may build up inside the cell. Yet one may still safely remove the plug after first running a small steel pin through the vent tube to release any pressure which may have built up internally. The plug may then be removed. This design may actually spare someone serious injury in the field, such as alkaline electrolyte splattered into the eyes or even explosion. The vent tube 13 may actually be used in the removal of explosive gases by fitting up to it an appropriate ventilation hose. This feature may prove important in situations where large banks are employed in unventilated space, such as in commercial telephone service.

Also shown more clearly in FIG. 2 is plate separator 4, depicted here in sectional form. The elongated ring of plate separator 4 surrounds the cathode assembly, at the core of which is cathode 5 made of special high-grade zinc. The assembly consists of cathode 5, terminal stud 6, a sheet of specially studded rubber 53, and plate separator 4. Stud 56 is a typical, integral molded rubber stud. After installing the terminal stud, the special sheet of studded rubber 53 is wrapped around the cathode. This special sheet is provided with serrated or semi-perforated edges, shown in FIG. 1 as 18. Their purpose is to permit ionic communication between anodes and cathode, but is designed in such a way as to prevent shorts caused by mossy zinc deposits which would otherwise grow outward and contact the anodes. This arrangement also permits the accumulation of zinc particulate matter, thus retaining it for cathodic activity. Plate separator 4 is made in such a way as to permit the device to be snugly fitted over the cathode assembly, thus firmly remaining in place. The long notches provided near the bottom of plate separator 4 are provided for the placement of the anodes during assembly, The width of the separator is such that the complete assembly, consisting of cathode, anodes and plate separator, vent tube, terminal hardware and cover should snugly fit into the cell container. A suitable silicone sealer is applied to the cell container or cell top prior to final assembly. After a specified curing period, the cell may be filled with electroyte. Sodium hydroxide may be successfully substituted for potassium hydroxide in many applications where high volume production warrants a particularly low cost, which is only possible by utilizing even more commonly available supplies than those specified in this description of the preferred embodiment.

After filling the cell, a small amount of special oil is added which floats upon the electrolyte. As previously noted, three parts mineral oil to one part lamp oil is a good formula which is relatively odor free. It has been found through considerable testing that oils much lighter than this mixture bear the stronger odor of the light oil and even though much refined is unsuitable in actual practice.

This cell must be activated prior to actual use. This normally consists of electrically charging the cell in the conventional way. However, additional conditioning which may in these cells mean nothing more than the there passage of time, may be necessary under certain circumstances before cell voltage reaches its normal level. This is usually no longer than a period of twenty-four hours. Occasionally, certain designs may require much longer conditioning, owing to a multitude of factors which are impossible to predict in such a great variety of cell styles made possible by this invention.

The unique principle of operation of this cell is best understood by first considering the anode and the reasons why the device replenishes its own electrical charge. FIG. 3 depicts the process of bipolar catalysis as it occurs in the cell. When immersed in an alkaline electrolyte, minute particles of iron 21 tend to become negatively charged and react with the electrolyte when minute particles of activated carbon are present. The carbon particles 20 become positively charged and therefore behave as anodes in relation to the iron which behaves cathodically. Coating 22 represents the product of this reaction, insoluble ferrous hydroxide, which forms in the presence of the carbon. Since all three substances are insoluble, these reactions take place without contributing any chemical product to the electrolyte. Hydroxyl ions are absorbed by the anode, however, much as they would by the application of an electrical charging current. The ferrous hydroxide then becomes the oxidant in relation to the zinc cathode of this battery, available in ready supply throughout numerous cycles without the need for electrical charging current. The supply of the oxidant in these cells is, by way of this example, constantly being replenished by the process of bipolar catalysis.

FIG. 4 is an illustration of this cell in its simplest possible form. Jar 23 contains an aquaous solution of potassium or sodium hydroxide 24 in which is immersed both cathode 26, made of pure zinc, and anode 25 constructed from a perforated steel tube filled with a mixture of 100 mesh activated carbon powder and 100 mesh iron powder. The holes in the tube are presumed small enough to retain the powdered contents without spillage. Due to the process of bipolar catalysis, the iron reacts with the electrolyte to form ferrous hydroxide within anode 25 due to the presence of finely divided activated carbon uniformly dispersed therein. As is illustrated in FIG. 3, the cell in FIG. 4 is constantly being supplied with a ready oxidant by this ongoing process and therefore a potential exists between the iron anode and the zinc cathode of approximately 1.25 volts. Upon discharge, the ferrous hydroxide within the anode is reduced to metallic iron and the zinc at the cathode is oxidized to form zinc hydroxide. While the cell illustrated is not likely to deliver more thirty milliamperes on such a small scale, one will note that after the cell is discharged, it will within hours regain a substantial portion of its charge. It will, in due course, resume its full prior energy level automatically. Owing to this remarkable characteristic, there is only a need for a more efficient design of this basic concept, along with of course a much larger capacity, to make such cells useful from a practical standpoint.

The important discharge reactions which take place within the cell are clearly expressed in FIG. 5 in the form of chemical equations. The three tier format is necessary in order to express the ionization of potassium hydroxide during the discharge process and to show how the oxidation-reduction reactions involving both metals are involved in this process. The theory of oxidation-reduction states that a transfer of electrons takes place from the reductant to the oxidant. The equations make clear that when zinc is oxidized by the two hydroxyl ions that zinc hydroxide is the chief product and that two electrons are given up in the process. Simultaneously, the positive potassium ions reduce the ferrous hydroxide to metallic iron, with a by-product of potassium hydroxide. Iron gains two electrons in the process. In practical cell applications, the flow of electrons takes place through a load by way of a conductor to do work.

FIG. 6 shows how these processes are reversed by either electrical charging or by way of the carbon catalyst previously described. Potassium hydroxide ionizes into separate potassium and hydroxyl ions. Iron is readily oxidized by the hydroxyl ions, aided substantially by the carbon catalyst, and ferrous hydroxide is produced, losing two electrons in the process. Meanwhile, the potassium ions are free to reduce the zinc hydroxide to metallic zinc. Potassium hydroxide is a by-product of this reaction and zinc regains two electrons in the process. In electrical charging, an external current somewhat higher than the cell's normal voltage is applied. The catalytic charging, or bipolar catalysis as it is best described, occurs automatically, but at a much slower rate. One must also consider that zinc is much more active than iron. In the bipolar catalytic process, free potassium ions are readily supplied to reduce zinc hydroxide. But one must consider that at all times the hydroxyl ions seek to oxidize the zinc thus reduced. Inevitably only a limited number of bipolar catalytic charges are possible. After approximately forty-five bipolar catalytic cycles, a surplus of zinc hydroxide is produced and results in saturation within the cell. The cell then suffers from a crystalline build-up of zinc hydroxide. The estimate of the number of bipolar catalytic cycles possible in each phase has been determined by actual testing and may vary under different conditions and styles of cells. Cell voltage is eventually reduced to zero potential as the crystalline deposit coats virtually the entire zinc cathode and brings a complete hault to oxidation. Fortunately, this crystalline deposit is readily broken down by electrical charging, thus restoring the cell to its original chemical state.

Having already discussed the theory of cell operation, practical considerations involving cost and ease of manufacture had to be addressed in order to make this chemistry suitable for the public on a large commercial scale. The actual forms of such features as the anode assembly for example, had to be those which would deliver the highest possible efficiency, while still being very cheaply manufactured from common materials, using known production techniques. If these matters of cost, efficiency and manufacture could not be addressed, such a system could not be made market-competitive, despite all of the other proven advantages of these cells. Therefore, the anode assembly described below is just one example of how success in practicality, cost and efficiency has been achieved in the present invention.

FIG. 7 is a detail drawing of the steel blank which is used to construct the anode assembly, shown in various stages of completion in FIG. 8 through FIG. 13. The thin steel blank must be designed according to the size and capacity of the cell it is to be placed in. Ordinarily for most cells they need be no heavier than 0.018 in thickness. The steel blanks, in high-speed production, are of course made as stampings according to known methods and by known machinery. After being perforated and stamped to the outline indicated in the drawing, the components are blued, again according to known oxidation processes. Bluing the steel tends to protect the anodes from rust, particularly above the electrolyte and near the terminals. Now pointing out the various features of the anode, anode tip 30 is provided with holes 36 in this exemplary anode. Fillets 33 are provided to encourage bending at specific points. Note that the various bends are indicated in the blank by way of phantom lines.

Anode shield 31 is slightly wider and longer than anode tip 30. This is made so in order to facilitate the folding of anode tip 30. in other words, it is designed in such a way as to permit the folding of anode tip 30 at the bend line indicated, yet falling somewhat short of that bend line in length. This permits the remaining bends to be performed without encumberance. The remaining features of the anode blank are three foldable tabs 27 shown on anode shell 32. Boss 35 is provided near the center of the connecting strip, and hole 34 is provided for terminal hardware, in those cases where mechanical fastenters are employed instead of spot-welding. The stamping is symmetrical in that the upper half of the part is technically identical to the lower half, indicating all the features just described.

FIG. 8 represents the actual assembly of the anode. A paste is prepared from equal volumes of 100 mesh powdered iron and 100 mesh activated carbon powder. The powders are thoroughly mixed dry and then the mixture is wetted with distilled water. Paste 28 is then applied to the anode tips at both ends, and is maintained uniformly flat and reasonably thin in coat. A folded and pre-sewn sack is prepared in advance of assembly for both ends of the anode assembly. Sack 29 is best constructed from a closely woven nylon fabric, The best nylon fabric for this purpose is a very fine, yet dense and tough fabric presently used in the manufacture of water repellant wear and other articles. While the malarial is truly water repellant, it is also permeable when submerged and is very resistant to alkaline attack. Nylon is simply given herein by way of example. It has excellant properties, including the ability to hold fine powders without spillage. Permeable alkaline resistant materials of similar characteristics are likely to be just as suitable.

Note that these sacks are to be first pressed and then stitched or sealed at the sides with a suitable nylon thread or other means in a way that will retain the finest powder. Sacks 29 are slipped over the anode tips by hand and a retaining stitch may be applied if deemed necessary. A stitch at each end of the fillets provided at the bend line is sufficient.

With both nylon sacks securely in place, the anode assembly undergoes various bends, to be accomplished either by hand or machine manipulation. These various stages in the bending process are described in FIG. 9 through FIG. 13. FIG. 9 illustrates the process of bending the anode tips inward, shown here at approximately 90°. FIG. 10 shows the bending process continued. FIG. 11 again depicts the sane anode assembly nearing the point in the bending process where shell 32 is directly underneath anode tip 30 and folded shield 31. Now looking at a top view of the device after these folds have been made, FIG. 12 shows how tabs 27 are folded over shield 31. Pressure is then applied to the tabs to secure the folded assembly while transforming it into a tight, compact entity which can successfully retain its insoluble contents. At the same timed the anode assembly is readily permeated by the alkaline electrolyte. FIG. 13 illustrates the final bends applied to the assembly, these both being 90° bends at the connective strip as depicted. Note that the typical bend radius is such that the material is not weakened in the process. The anode assembly thus shown may be used independently in such a cell, or it can be doubled. It may even be tripled or quadrupled. The important note for reference in designing the blanks for these assemblies is regarding length “L” noted in FIG. 13 “L” must be increased for each “saddle-bag” which is to be mounted over the original anode assembly. In other words, if multiple assemblies are planned, various anode blanks must be individually designed and separately manufactured. A good rule of thumb for “L” is approximately one half inch increase in length for every subsequent anode assembly to be mounted over the original. Therefore, in pairs of two, four, six, etc., each pair added to the original must show an increase in length, on the average, of one half inch in additional connective strip length to make such multiple assemblies possible. The actual increase in efficiency is likely to be slightly less in overall terms with the addition of each subsequent assembly. Since the energy level increase per pair must be weighed against their additional cost, no set number of pairs can be predicted for every design case. The anodes, however, are relatively inexpensive and the multiple anode design can be used to boost efficiency at a minumum in terms of cost.

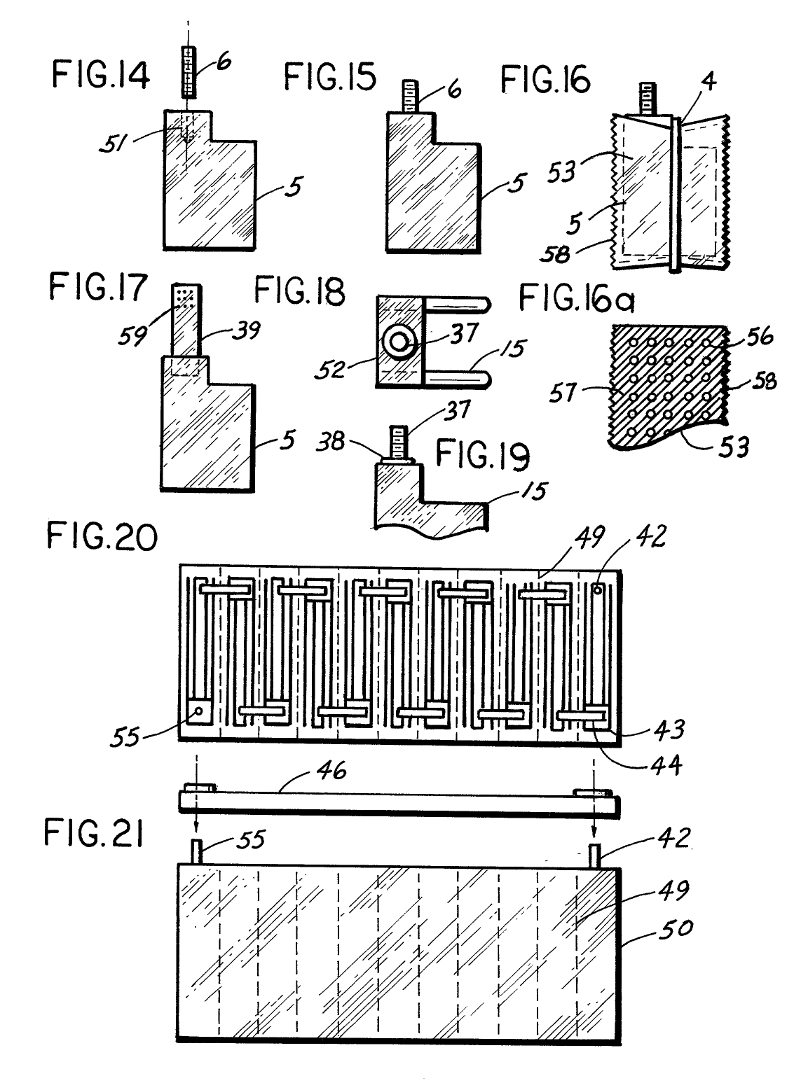

Continuing the decription now to include the cathode assembly, FIG. 14 shows basic cathode 5 as it is cast from special high grade zinc. The top of the cathode is then drilled, depicted in the drawing as hole 51, and then tapped to accomodate stud 6. As was previously outlined in this specification, the internal threads are to be cleaned with an appropriate solvent and allowed to dry. The male threads of stud 6 are to be coated with a suitable silicone sealer prior to installation. After threading stud 6 into the cathode, it should be tightened properly to prevent the stud from loosening later, after secondary terminal hardware is added. Other sealant products are not to be ruled out as having some value in these assemblies. At the present time, however, this product has been found to be highly suited to the application. In industrial production, a special tool is advised for tightenting the terminal stud as the entire length of the part is threaded and somewhat difficult to grasp without doing damage to the threads. FIG. 1 depicts the zinc cathode after the terminal stud has been properly installed.

FIG. 16 is an assembly drawing which depicts the application of a special sheet of studded rubber 53 and plate separator 4 onto zinc cathode 5, thereby completing the cathode assembly, ready for installation in the cell. As previously mentioned in this specification, one of the difficulties in utilizing zinc in alkaline wet cells is the tendency for zinc to deposit mossy zinc under certain circumstances. Although these dendrtic formations pose no potential threat to simple cells designed with adequate space between cathodes and anodes, in very compact cells designed for high efficiency the situation is very different. Although it is not known with any degree of certainty why these formations develop, some facts seem to point to the breakdown of the deposits of zinc hydroxide crystals which tend to form on the cathode. In the absence of these deposits, the zinc is attracted to the cathode during charging, but the actual deposits are more on the order of spongy zinc. These deposits are far more manageable than the mossy dendrite formations. The permanent connection of such cells to a solar panel may help prevent mossy zinc from forming altogether, as the zinc hydroxide deposits precursory to their formation never crystalize. Mossy dendrite deposits may also be discouraged by a lower relative charging voltage. This should be kept below 3.0 volts. 2.2 volts is much more acceptable. This ma appear to be a rather high. Charging voltage for a cell of 1.25 volts but quite frankly, during charging, cell voltage tends to climb sharply to nearly two volts. This is only temporary but questions arise as to what the appropriate charging voltage should be. Therefore, the rule of thumb established from very limited experience with a new cell, restricts the charging voltage range to the limits of 6.0 volts at maximum to 1.5 volts are bare minium. The optimum, for the timebeing, should be set at around 2.0 volts as this appears to be an acceptable charging level for individual cells and batteries of two or three cells utilizing of course the number of cells as a multiplier. Therefore, three cells in series might charge at 6.0 volts, while their average output together may only be 3.75 volts. Higher voltages of even 6.0 volts per cell in charging voltage appear to do little if any damage and fortunately, one may add another advantage to a list of improvements over lead cells because charging at this voltage level seems to be much faster and appears to require little or no voltage regulation.

Lacking any perfect method of preventing dendritic mossy zinc deposits altogether, special studded rubber sheet 53 is a specialized component designed to manage them effectively within the cell when they do occur. Most importantly, it prevents these deposits from shorting against the anodes. FIG. 16a is a detail drawing of special studded rubber sheet 53 and is added as a supplement to the assembly shown in FIG. 16 in order to depict the important detail on its underside, otherwise not clear in FIG. 16 Again referring to FIG. 16a, special studded rubber sheet 53 is provided with integrally molded studs 56. Also provided are diagonal grooves 57 which aid in ionic communication and serve more important purposes in larger cells where narrow rubber strips of this design are substituted for one single piece. This permits greater ionic communication and therefore improved efficiency in larger cells. In these cases, the narrow strips must be overlapped at least three-quarters of an inch. Each strip is held in place by a plate separator such as depicted as item 4 in FIG. 16. Even though the dendrites may grow into the grooves, the odds of a short are greatly minimized. In simple cells, such as the examples depicted herein, one single sheet wrapped around the cathode is preferred. The rubber is to be non-porous also, as mossy zinc will grow even through the finest of pores. The serrated edge 58 provided on both sides of the sheet, or instead a semi-perforated or other similar design such as illustrated in FIG. 1, has the effect of providing small ports in which ionic transfer may take place without permitting mossy zinc to contact the surface of the anodes and thereby shorting the cell. Again, as stated earlier on in this specification, a surprising find in the cell research and development was that solid rubber sheets caused little change in cell efficiency when placed between cathode and anode in these cells, so long as gaps or ports remained along the edges to permit ionic transfer. Indeed the lead-acid scheme in common use is similar in some respects, but porous separators are much more common.

Now referring to FIG. 17, an alternative to cathode design previously shown is provided for batteries in which a number of cells are grouped in series. FIGS. 17, 18, 19, 20, and 21 as well as the rubber sheet detail mentioned in FIG. 16 and FIG. 16a, all have bearing on the adaptation of these cells to large batteries incorporating series connections. Of course in lead cells the soft metal with a low melting point has always proved ideal for establishing these connections. Iron-zinc cells offer no such simple advantage. In FIG. 17, steel connective strip 39 may be galvanized prior to use. During the molding of cathode 5, the molten zinc present in the mold after pouring represents an ideal opportunity to incorporate steel connective strip 39. Not only being galvanized or even hot-dipped half this strip may also be electroplated with copper during its manufacture and tinned with solder, anticipating the soldered connection atop the anode connective strip 52, as depicted in FIG. 18. This strip is less the terminal stud shown in this view which is only used at the positive connecting post as illustrated in FIG. 20. Fixtures must be provided of course to hold the strip in the proper position as the zinc hardens.

FIG. 18 is a top view of the anode assembly of a cell bound for use in a multi-cell battery. In this case, terminal 37 has been spot-welded to the otherwise plain surface of steel connective strip 52. The actual anodes should be shielded from weld splatter and kept cool during the stud welding process. Prior to soldering, if a sealer is to be applied to the top by pouring, a special template must now be placed over the assembly to accept the sealer in liquid form. This template must conform to the outline illustrated, should be made of plastic and must permit protruding components without leakage during the pouring process. If a sealant is not poured, then the electrical connections must be coated at minimum to prevent disintegration of the solder by the alkaline electrolyte. Various lacquers, tung oil products, silicone compounds, etc. are among the possible choices. The electrical connections, made prior to coating or pouring, are made upon the tops of the anode connective strips 43. These are ready to accept the cathodic terminal strips 39 which are simply bent over and soldered to the tops of the anode connective strips. Perforations 59 are provided at the soldered ends of strips to aid in solder flow during assembly.

FIG. 20 is a schematic top view of a multi-cell battery in which all important components have been installed as specified herein and with series electrical connections made by soldering, preferably with a lead-free solder. Cell compartment walls 49 are shown by phantom lines only to verify the electrical connections and the basic mechanical features of the battery. This is a 12 volt battery. Plate separators, the special studded rubber sheet, and a plastic template used if a sealant is to be poured over the top of the battery are not shown for schematic clarity.

FIG. 21 is a side view of the same battery, with all the important components described in this specification having been properly installed. After applying a special protective coating to the soldered connections as previously mentioned, a sealer may be applied over a template as necessary to serve as a containment tray under and above the electrical connections to be protected. This detail is also ommitted for the sake of clarity in the drawing. Then applying a silicone sealer to cover 46, case 50, and at the terminals, the cover may be securely installed over case 50, much the same as in lead batteries of present manufacture. The necessary fill and vent provisions having been provided in the cover 46, the battery may be filled with electrolyte and topped off with the special oil mixture previously described. The battery is then ready for an electrical charge and a period of conditioning necessary in this type of cell. The battery is then ready for use and remains active for about six weeks. If not used in a conventional storage battery application within six weeks, the battery goes into a dormant phase and must be charged again to make it active once more. As was previously stated, this is due to the coating of zinc hydroxide crystals present on the surface of the zinc cathode which protect the cathode from further action. This feature also permits batteries to be warehoused in the wet state for long periods of time in the dormant phase, so long as the electrolyte levels are maintained.

In other words, batteries such as those described in this specification have as their inherent characteristics both an active phase and a dormant or inert phase. The active phase has been found to be approximately six weeks. The dormant phase can simply be a short period of time until the battery is charged, or it can be indefinite. Indeed, if the electrolyte levels are maintained, the protective oil layer will permit a shelf life of many, many years in the dormant phase. The active phase is determined by the length of time required for the crystals of zinc hydroxide to form due to saturation, thus coating completely the entire surface of the cathode. This period can be lengthened by diluting the electrolyte or increasing the amount of electrolyte present within the cell. This also requires increasing the capacity of the cell container relative to the sizes of the anodes and cathode. This simply permits more zinc hydroxide to dissolve and therefore delays saturation.

Batteries described in this specification therefore exhibit new, novel and environmentally sound characteristics and chemistry not found in batteries of the past. Indeed, a practical substitute for the lead-acid cell, as well as various forms of nickel cells, this battery shows marked improvement over the carbon-zinc cell in that it is rechargeable and low in cost when constructed in large capacity. Having described the invention in detail, in no way is the scope of this invention to be considered limited by the preferred embodiments depicted herein.

What is claimed is:

1. An alkaline electrochemical cell, comprising:
(a) a suitable container with an initially open top end;
(b) a cathode assembly comprising a cathode of zinc, a steel conductor securely imbedded in the cathode and extending outward, the cathode being wrapped in a special sheet of studded insulating material provided with a semiperforated edge on both sides permitting ionic communication, a plate separator comprising an oval-shaped annular ring with a wide flat bottom made of a suitable insulating material provided with a plurality of vertical notches corresponding to the anodes securely placed within them;
(c) an anode assembly comprising one or more anodes, comprising initially one or more special steel stampings, further comprising in one component an electrically conductive connecting strip, one or more anode shells, each being perforated and provided with a plurality of foldable tabs, one or more anode shields, each being perforated and directly adjacent to their respective shells, one or more perforated anode tips coated with a paste comprising a mixture of iron powder and carbon powder properly wetted, the anode tips being covered with sacks comprising a permeable alkaline resistant material initially folded and sealed on each side, the anode tips being folded over the anode shields, the anode tips and the anode shields together being folded over the anode shells, the foldable tabs of the anode shells being bent over and subjected to slight pressure to secure the assembly, the anode assembly being bent twice more at the connecting strip until the anodes are parallel and the connecting strip is perpendicular to both, and a steel conductor securely affixed to the connecting strip and extending outward;
(d) an alkaline aquaous electrolyte comprising a solution of potassium hydroxide in water;
(e) a cell cover having an opening for pouring liquid into the cell, closure means provided to close the opening, ventilation means, and holes provided for terminal studs.

2. An alkaline electrochemical cell as in claim 1, wherein an oil layer floats atop the electrolyte, the oil layer comprising a mixture of mineral oil and a lighter lamp-grade oil.

3. An alkaline electrochemical cell as in claim 1, wherein an oil layer floats atop the electrolyte, the oil layer comprising a general duty petroleum oil.

4. An alkaline electrochemical cell as in claim 1, wherein the anodes of such cell are blued by known oxidation means.

5. An alkaline electrochemical cell as in claim l, wherein the sacks covering the anode tips comprise finely woven nylon.

6. An alkaline electrochemical cell as in claim 1, wherein the conductor imbedded in the cathode is a threaded stud of stainless steel.

7. An alkaline electrochemical cell as in claim 1, wherein the conductor imbedded in the cathode is a threaded stud of low carbon steel.

8. An alkaline electrochemical cell as in claim 1, wherein the conductor imbedded in the cathode is a flat steel connective strip, installed while the zinc is molten.

9. An alkaline electrochemical cell as in claim 1, wherein the steel conductor securely affixed to the connecting strip of the anode assembly is a threaded steel stud, spot-welded onto the said connecting strip.

10. An alkaline electrochemical cell as in claim 1, wherein the steel conductor securely affixed to the connecting strip of the anode comprises a threaded stainless steel stud, a special nut further comprising a cylinder, open at one end, threaded internally, said cylinder having an annular lip at the opposite end, said special nut being made from low-carbon steel, the special nut fitting through a hole provided in the connecting strip up to the annular lip which, when a sealer is applied and a nut applied to the opposite end, the assembly providing a tight, electrically conductive system.

11. An alkaline electrochemical cell as in claim 1, wherein the special sheet of studded insulating material is rubber.

12. An alkaline electrochemical cell as in claim 1, wherein the special sheet of studded insulating material has a serrated edge.

13. An alkaline electrochemical cell as in claim 1, wherein the special sheet of studded insulating material is made with diagonal grooves on at least one side of, the material.

14. An alkaline electrochemical cell as in claim 1, wherein the carbon powder mixed with the iron powder to form a paste is activated carbon powder.

15. An alkaline electrochemical cell as in claim 1, wherein the cells are multiplied, share a common partitioned container and are connected in series.

16. An alkaline electrochemical cell, comprising:
(a) a suitable container with an initially open top end;
(b) a cathode assembly comprising a cathode of zinc, a steel conductor securely imbedded in the cathode and extending outward, the cathode being wrapped in a special sheet of studded insulating material provided with a semiperforated edge on both sides permitting ionic communication, a plate separator comprising an oval-shaped annular ring with a wide flat bottom made of a suitable insulating material provided with a plurality of vertical notches corresponding to the anodes securely placed within them;
(c) an anode assembly comprising one or more anodes, comprising initially one or more special steel stampings, further comprising in one component an electrically conductive connecting strip, one or more anode shells, each being perforated and provided with a plurality of foldable tabs, one or more anode shields, each being perforated and directly adjacent to their respective shells, one or more perforated anode tips coated with a paste comprising a mixture of iron powder and carbon powder properly wetted, the anode tips being covered with sacks comprising a permeable alkaline resistant material initially folded and sealed on each side, the anode tips being folded over the anode shields, the anode tips and the anode shields together being folded over the anode shells, the foldable tabs of the anode shells being bent over and subjected to slight pressure to secure the assembly, the anode assembly being bent twice more at the connecting strip until the anodes are parallel and the connecting strip is perpendicular to both, and a steel conductor securely affixed to the connecting strip and extending outward;
(d) an alkaline aquaous electrolyte comprising a solution of sodium hydroxide in water;
(e) a cell cover having an opening for pouring liquid into the cell, closure means provided to close the opening, ventilation means, and holes provided for terminal studs.

17. An alkaline electrochemical cell as in claim 16, wherein an oil layer floats atop the electrolyte, the oil layer comprising a mixture of mineral oil and a lighter lamp-grade oil.

18. An alkaline electrochemical cell as in claim 163 wherein the carbon powder mixed with the iron powder to form a paste is activated carbon powder.

19. An alkaline electrochemical cell as in claim 16, wherein the special sheet of studded insulating material is made with diagonal grooves on at least one side of the material.

20. An alkaline electrochemical cell as in claim 16, wherein the cells are multiplied, share a common partitioned container and are connected in series.
